(19) United States
(12) Patent Application Publication
(10) Pub. No.: US 2026/0209521 A1
(43) Pub. Date: Jul. 23, 2026

(54) RADAR TRANSPARENT MIXTURES OF METAL EFFECT PIGMETS WITH SEMICONDUCTOR EFFECT PIGMENTSOR SEMICONDUCTOR EFFECT PIGMENTS WITH SILVERY ABSORBING PEARLESCENT PIGMENTS AND COATING FORMULATIONS THEREOF

(71) Applicants: ECKART GMBH, Hartenstein (DE); ECKART AMERICA COPORATION, Painesville, OH (US)

(72) Inventors: Devin Schmitt, Munster, IN (US); Christopher Hilbrich, Crown Point, IN (US); Jonglak Choi, Munster, ID (US); Alexandra Preiss, Bayreuth (DE); Annika Mergner, Burgthann (DE)

(21) Appl. No.: 19/140,476

(22) PCT Filed: Dec. 15, 2023
(86) PCT No.: PCT/EP2023/085998

§ 371 Date: Jun. 18, 2025

Related U.S. Application Data
(60) Provisional application No. 63/434,126, filed on Dec. 21, 2022.

(30) Foreign Application Priority Data
Jan. 27, 2023 (EP) 23153729.1

(51) Int. Cl. C09C 1/00; C09D 5/24; C09D 5/36

(52) U.S. Cl. CPC C09C 1/0018; C09C 1/0051; C09D 5/24; C09D 5/36; C01P 2004/24; C01P 2004/80; C01P 2006/40; C01P 2006/60; C09C 2200/1054; C09C 2200/301

(57) ABSTRACT

This invention deals with effect pigment mixture comprising a mixture of flaky single layered semiconductor effect pigments and flaky metal effect pigments or a mixture of flaky single layered semiconductor effect pigments with silvery absorbing pearlescent pigments, wherein the flaky single layered semiconductor effect pigments have a bandgap in a range of 0.1 to 3.9 eV.

The present invention relates to a radar transparent effect pigment mixture comprising metal effect pigments and single flaked semiconductor flakes and coating formulations comprising this effect pigment mixture.

US 2005/0252416 A1 discloses a mixture of a PVD aluminum pigment with a pearlescent pigment. Radar transparent coatings comprising this mixture are not disclosed therein.

The use of radar is becoming ubiquitous in modern transportation including passenger vehicles with advanced driver assistance systems (ADAS), such as adaptive cruise control (ACC), automatic breaking, and the like. The use of radar will likely further increase as higher levels of autonomous driving are implemented. Radar performance can be hindered by unwanted radar signal loss, which may result from the use of metallic pigments, such as aluminum flakes, commonly used in coatings to achieve a certain luster, sparkle, flop and/or a metallic color. Coatings, films, and articles of manufacture that minimize interference with radar while providing the desired appearance are desired.

US 2010/0022696 A1 disclosed a radar transparent mixture of metal effect pigments and pearlescent pigments. Aluminum effect pigments obtained from milling processes or from PVD deposition processes were disclosed. The aluminum pigments have to be used in such concentrations that they have a certain distance to each other in order to not to act as “large” particles which can adversely reflect radar microwaves. The attenuations obtained were in the order of less than 1.0 dB. Such effect pigments mixtures, however, did not obtain good hiding power as the pearlescent pigments used were rather transparent. Furthermore, the coatings systems described therein do not match current demands of coatings thicknesses' or effect pigments concentrations.

This drawback was overcome by US 2022/0145082 A1 which disclose a mixture of milled aluminum effect pigments and certain silvery pearlescent pigments. With such mixtures existing automotive full-tone silver formulations could be matched with rather low concentrations of effect pigments and a radar transparency of below 3.0 dB was reached.

A mixture of metallic aluminum pigments with pearlescent pigments was also disclosed in US 2021/0040329 A1.

Another solution without the use of metallic pigments was disclosed in WO 2022/064018 A1. Herein, a first base-coat layer pigmented without effect pigments but with absorbing pigments and thereon a second base-coat layer pigmented with effect pigments was disclosed. The effect pigments in the second base-coat are pearlescent pigments and also silvery absorbing pearlescent pigments were used. However, such two-coat setup would increase costs of the base coats and also the resulting coatings had rather low brightness.

Another two base coat system was disclosed in WO 2022/049041 A1, wherein a first base coat without effect pigments but with absorbing pigments and thereon a second base-coat layer pigmented solely with metallic effect pigments was disclosed. Again, such two-coat system solution will be to cost intensive for automotive industry.

WO 2022/011131 A1 discloses coatings with a compound pigment comprising a non-conductive composite comprising a semiconductor and/or a dielectric, and a metal dispersed in and/or on the semiconductor and/or dielectric, wherein the pigment has an aspect ratio of at least 5, such as, at least at least 10, at least 50, at least 100, at least 500, or at least 1000 wherein the aspect ratio is an average lateral size of the pigment divided by an average thickness of the pigment. These composites were produced with PVD methods. However, such composites are difficult to reproduce. Furthermore, the coating industry has less possibilities of coloristic variations as in these compounds the ratio of the semiconductor or the dielectric and the metallic parts are fixed.

Therefore, there is still a need to further reduce the radar transparency of metallic coatings having at the same time a very high hiding power and metallic appearance with respect to flop and brightness. Such effect pigments should be applicable in a single base coat.

This object can be achieved by providing an effect pigment mixture comprising a mixture of flaky single layered semiconductor effect pigments and flaky metal effect pigments or a mixture of flaky single layered semiconductor effect pigments with silvery absorbing pearlescent pigments, wherein the flaky single layered semiconductor effect pigments have a bandgap in a range of 0.1 to 3.9 eV.

Further preferred embodiments of this effect pigment mixtures are disclosed in claims 2 to 12.

The object of the invention is further provided by a coating formulation which contains the effect pigment mixture (claim 13).

### DESCRIPTION

### Flaky Single Layered Semiconductor Effect Pigments:

The flaky single layered semiconductor effect pigments are preferably made from a semiconductor material having a bad gap in a range of 0.1 to 3.9 eV. Typical materials (with their band gaps in eV in brackets) are zinc oxide (3.37), zinc sulfide (3.56), zinc selenide (2.70), gallium arsenide (1.42), gallium phosphide (2.26), gallium antimonide (0.69), indium phosphide (1.27), indium arsenide (0.36), indium antimonide (0.17), aluminum arsenide (2.16), aluminum antimonide (1.58), cadmium sulfide (2.42), cadmium selenide (1.74), cadmium telluride (1.45), silicon (1.12) and silicon-alloys (0.05-1.12), germanium (0.67) and germanium alloys (0.05-0.67).

More preferably the flaky single layered semiconductor effect pigments are made from a semiconductor material having a bad gap in a range of 0.2 to 1.9 eV and most preferably in a range of 0.2 to 1.4 eV. Within these smaller ranges of the bandgap more electromagnetic radiation in the visible range can be absorbed and therefore the opacity increases.

With “band gap” the band gaps of the semiconductor materials as commonly known in the art at a temperature of 300 K and referring to bulk literature values are meant.

Most preferred the flaky single layered semiconductor effect pigments are made from silicon and silicon-alloys, germanium and germanium alloys. These materials are preferred due to their low toxicity and easy accessibility.

In this invention the flaky single layered semiconductor effect pigments most preferably have an average atomic composition of:
a) Si₍₁₋ₓ₎Geₓ, wherein 0≤x<1.00 or
b) Si_{(1-y)}Sn_{y}, wherein 0<y<0.90 or
c) Ge_{(1-z)}Sn_{z}, wherein 0<z≤0.60 or
d) Si₍₁₋ₘ₋ₙ₎GeₘSnₙ, wherein 0<m<1.00 and 0<n<1.00 and with the provisos that x<1.00; y<1.00, z<1.00 and m+n<1.00.

The x, y, n and m are mole fractions. In further preferred embodiments the single platelet semiconductor according to a) has a composition of 0.01<x<0.9, more preferably 0.02≤x≤0.8 and most preferably 0.05≤x≤0.65. These materials are alloys of silicon and germanium. Germanium adds interesting color effects as this material is absorbing in the visible wavelength region. This also enhances the opacity compared to pure silicon flakes. Due to the high costs of this material the content of germanium is preferably as low as possible.

In further preferred embodiments the single platelet semiconductor according to b) has a composition of 0.02≤y≤0.75 and more preferred of 0.05≤y≤0.55. These materials are alloys of silicon and tin.

In further preferred embodiments the flaky, single platelet semiconductor according to c) has a composition of 0.02≤z≤0.5 and more preferred a composition of 0.05≤z≤0.4. These materials are alloys of germanium and tin.

In further preferred embodiments the flaky single platelet semiconductor according to d) has a composition characterized by 0.02≤m≤0.8 and 0.02≤n≤0.75 and more preferred a composition characterized by 0.05≤m≤0.65, 0.05≤n≤0.55.

With the term “single layered” it is meant that the flaky single layered semiconductor effect pigments have one optically active layer which consists of the semiconductor layer. This effect pigment does not contain further layers like a metal layer or a “multilayer” structure such as a low-refractive layer followed by a high refractive layer or a second semiconductor layer.

The single layered semiconductor effect pigment may, however, optionally be further coated with optical non-active layers. Typically such non-active layers have a mean refractive index in the visible wavelength region of less than 1.7, more preferably less than 1.6. In this invention such non-active layers preferably have an optical density of less than 34 nm and more preferably less than 30 nm in the visible wavelength region. Herein, the refractive index refers to literature bulk values of the respective material rather than the effective refractive index of the layer.

In preferred embodiments the optically non-active layer encapsulates essentially the whole semiconductor platelet and consists of a layer of SiO₂, Al₂O₃, B₂O₃ or mixtures thereof. As the semiconductor platelets are usually gassing stable by themselves such further optically non-active layers are rather utilized to further enhance the binding capability of optional further surface modifiers like organofunctional silanes, titanates, aluminates or zirconates, phosphate ester, phosphonate acids, phosphite esters, alcohol or amine-based additives and combinations thereof. Such surface modifiers are used in certain embodiments as top-coating to adjust the chemical compatibility of the effect pigment to the binder medium of the final application as described e.g. in EP 1084198 A1. They can be coated either directly on the single semiconductor platelet pigment or on the optically non-active layer. Most preferred as surface modifiers are organofunctional silanes. In another preferred embodiment the semiconductor platelet is coated first by a thin layer of SiO₂ and then coated with suitable surface modifiers, most preferably organofunctional silanes. The SiO₂ layer here is primarily used to enhance the adhesion of the organofunctional silanes to the surface of the semiconductor platelet.

The platelet semiconductor particles may further contain usual impurities occurring by the manufacture of the materials such as carbon, nitrogen or oxygen. These materials are not included into the formulas mentioned above.

Impurities of other metals or other semiconductor materials not contained into the formulas above are typically less than 0.1 wt.-%, preferably less than 0.05 wt.-%, more preferably less than 0.005 wt.-% of the platelet semiconductor material and are also not included into the formulas above.

The platelet semiconductor particles may further contain some amounts of oxygen due to surface oxidation. For example, a platelet alloy semiconductor flake may be oxidized on its surface. This kind of oxygen is also not included in the formulas for the sake of clarity. Preferably the platelet semiconductor particles do not contain any noticeable amount of oxygen in their interior.

The platelet semiconductor particles do not contain other materials like metals in their interior or on their surface but are composed of the semiconductor material only with the restrictions described above.

The semiconductor platelets have a solid constitution with a low or without porosity in its inner structure. The porosity as determined by mercury porosity measurements is either essentially zero or cannot be determined at all because of the lack of porosity. The effect pigments are preferably produced by PVD methods. Their main surfaces (top and below) are rather flat and smooth as typical for PVD effect pigments. Such smooth structures and the absence of noticeable inner porosity enable the platelets to act with optimal reflectance.

Due to the high refractive index of these materials in the visible wavelength region the platelet semiconductor particles exhibit a rather strong reflection. Depending on the thickness of the semiconductor platelets various colors may be produced.

Accordingly the average thickness t_{sc} of the single semiconductor platelet is preferably in a range of 5 to 160 nm, more preferably in a range of 10 to less than 140 nm and most preferably in a range of 15 to 130 nm. With “average thickness” the arithmetical mean of a sample of pigment thickness' is meant.

Above an average thickness t_{sc} of 160 nm the platelet semiconductor might not be well oriented in the final coating formulation and the hiding power is reduced significantly. Below 5 nm of the average thickness t_{sc} the platelets may become mechanically unstable and may be difficult to be reproduced in sufficient quality.

The t_{sc}-value is determined by counting the thickness distribution of the platelets using SEM by first washing the dispersion of the semiconductor flakes with acetone and then drying them. The semiconductor powder is than poured onto a conductive adhesive label (Spectro tabs from Plano GmbH, Germany). By this procedure, a certain amount of the flaky semiconductor pigments become fixed into an upright position. Under the SEM these particles can be well identified and their thickness at the pigments edge be determined. For each sample about 100 particles were counted and the average thickness t_{sc} was determined. The same method can be applied to determine the average thickness t_{M} of flaky metal effect pigments if they are not covered with additional coatings.

In preferred embodiments the flaky effect pigments have a silvery appearance with an average thickness t_{sc} of the single semiconductor platelet in a range of 12 to 40 nm and preferably in a range of 18 to 35 nm. Especially preferred for such kind of flaky effect pigments are Si—Ge or Si—Sn alloys as previously described.

With a “silvery appearance” or a “neutral color tone” it is meant in this invention that in an application of these effect pigments a color neutral chroma effect over all measured angles (−15°, 15°, 25°, 45°, 75° and) 110° is achieved when the absolute values of the a*- and b*-values are independently to be less than 6.5, more preferably less than 4.0 and most preferably less than 2.0 units in the CIELab color space. Preferably the application as described in the draw-down in the experimental section are used here.

In other embodiments the flaky semiconductor effect pigment has a colored appearance with a median thickness t_{sc} of the single semiconductor platelet in a range of larger than 40 to 160 nm. Here the absolute values of the a*- and b*-values range independently are equal or more than 6.5 units in the CIELab color space

Due to their rather high refractive index the semiconductor flakes have a much higher opacity compared to pearlescent pigments. Therefore, the mixture of these effect pigments with flaky metal pigments have a higher hiding power compared to the mixtures disclosed in US 2022/0145082 A1. Surprisingly, also mixtures of the flaky single layered semiconductor effect pigments with silvery absorbing pearlescent pigments have a sufficient opacity and at the same time essentially no radar attenuation.

Regarding the sizes and size distributions of the flaky single layered semiconductor effect pigments typical size ranges of coatings in the automotive industry or of industrial coatings are chosen. Preferably, the flaky semiconductor effect pigments have a D_{50,sc} of the particle size distribution is in a range of 2 to 100 μm, more preferably in a range of 5 to 40 μm, furthermore preferred in a range of 6 to 35 μm and most preferably in a range of 9 to 30 μm.

The pigment size is typically indicated using quantiles (D values) from the volume averaged particle size distribution. Here, the number indicates the percentage of particles smaller than a specified size contained in a volume-averaged particle size distribution. For example, the D₅₀ value indicates the size where 50% of the particles are smaller than this value. These measurements are conducted e.g. by means of laser granulometry using a particle size analyzer manufactured by Horiba and is a Horiba LA 950 instrument. The measurements are conducted using Fraunhofer approximation for equivalent spheres and suitable parameters according to information from the manufacturer.

The D_{10,sc}-values characterize the amount of fine particles and typically range from 2 to 20 μm and preferably from 4 to 15 μm for the flaky single layered semiconductor effect pigments.

The D_{90,sc}-values characterize the amount of coarse particles and typically range from 15 μm to 140 μm and preferably from 20 μm to 50 μm for the flaky single layered semiconductor effect pigments.

With “flaky” single layered semiconductor effect pigments it is meant the aspect ratio (ratio of D₅₀ to average thickness t_{sc}) is at least 15, more preferably at least 30 and most preferably at least 100. Only such flaky single semiconductor effect pigments can orient in a plan-parallel manner in the final application system to impart enough specular reflection.

### Method of Manufacturing Flaky Single Layered Semiconductor Effect Pigments:

A method of manufacturing the flaky semiconductor effect pigment comprises the steps:
I) providing a flexible substrate coated with a release agent,
II) evaporating under ultra-high vacuum conditions a semiconductor material with a band gap in a range of 0.1 to 2.5 eV and having an average atomic composition of:
a) Si₍₁₋ₓ₎Geₓ, wherein 0≤x<1.00 or
b) Si_{(1-y)}Sn_{y}, wherein 0<y<0.90 or
c) Ge_{(1-z)}Sn_{z}, wherein 0<z≤0.60 or
d) Si₍₁₋ₘ₋ₙ₎GeₘSnₙ, wherein 0<m<1.00, 0<n<1.00 with the provisos that x<1.00; y<1.00, z<1.00 and m+n<1.00,
onto the flexible substrate a),
III) stripping the semiconductor film from the flexible substrate in a suitable solvent and comminuting the particles in the dispersion to obtain semiconductor flakes,
IV) separating the semiconductor flakes from the solvent and
V) optionally conducting further steps like any of further size classifying of the semiconductor flakes or dispersing the semiconductor flakes in a different solvent and further surface treatment steps.

Step I): This step is conducted essentially in the same manner than known from the manufacture of PVD metal pigments, especially aluminum effect pigments. The flexible substrate is usually a web made from polymers and most preferably a PET polymer. As release agents those common in the art can be used. Usually the release agents are polymers like for example acrylics, methacrylics, cellulose-based polymers or polystyrol. They can be also other organic materials as described in US 2004/0131776 A1 or in US 20100062244 A1.

In a preferred embodiment step II) is done by a roll-to-roll process. In step II) in one embodiment semiconductor alloys of a predetermined composition are used as bulk materials which are evaporated by suitable means to produce respective gas molecules which are transferred to the flexible substrate coated with a release layer under ultra-high vacuum conditions. In another embodiment two or three suitable bulk semiconductor materials of a predetermined purity are used wherein their vapor clouds are allowed to overlap before reaching the substrate.

Step II) can be conducted as an electron beam process, magneton sputtering, resistive evaporation or inductive heating. Most preferred is evaporation of the semiconductor bulk material by an electron beam process.

Steps III), IV) and V) are again well known in the art. Preferred solvents for stripping of the semiconductor film from the flexible substrate is acetone, ethyl acetate, propylene glycol methoxy ether, isopropyl alcohol, ethanol, or water.

### Flaky Metal Effect Pigments:

The flaky metallic pigments used for the effect pigment mixture are preferably PVD aluminum pigments or aluminum pigments obtained by milling of aluminum powder.

The aluminum pigments obtained by milling of aluminum powder are typically made in ball mills according to the well-known Hall process using a solvent like white spirit, solvent naphtha or isopropanol and as grinding aids fatty acids such as palmitic acid, stearic acid, oleic acid or mixtures thereof.

The particle size distribution is measured by laser scattering granulometry using a Helos/BR Multirange (Sympatec) apparatus according to the manufacturer indications and in accordance with ISO 13320-1. The aluminum effect pigments are dissolved in isopropanol under stirring before measuring the particle size distribution.

The platelet-like aluminum effect pigments preferably have a D_{50,M} in a range of 9 to 30 μm and more preferably in a range of 12-27 μm. Below a D_{50,M} of 9 μm the metallic appearance, especially the flop is too low. Above 30 μm the structure of the coating layer including the aluminum pigments becomes visible to the observer. Especially in automotive coatings this is an undesirable effect.

Preferably, the platelet-like aluminum effect pigments have a D_{90,M} in a range of 18 to 45 μm and more preferably in a range of 20 to 42 μm. Above a D_{90,M} of 45 μm some restrictions may occur with respect to sieving specifications of coating companies. In further embodiments, the platelet-like aluminum effect pigments of the effect pigment mixture comprises a mixture of finer and of coarser aluminum effect pigments. The “finer” aluminum effect pigments add a better hiding power while the “coarser” aluminum effect pigments contribute to a high flop and brilliance. The finer aluminum effect pigments of such a mixture typically have a D₅₀ in a range of 9 to 13 μm and the coarser aluminum effect pigments typically have a D₅₀ in a range of 18 to 26 μm. Of course, the characteristic values of D₅₀ or D₉₀ of the total size distribution of such a mixture changes according to the characteristics of the two individual size distributions and the proportion of the two aluminum effect pigments. Bimodal particle size distributions may be possible in this case.

The flaky aluminum effect pigments obtained by milling preferably have a mean thickness tₘ in a range of 80 to 500 nm and more preferably in a range of 140 to 400 nm.

Above 500 nm the hiding power of the metallic effect pigments is too low.

In case of PVD aluminum pigment the mean thickness is preferably in a range of 20 to below 80 nm, more preferably in a range of 25 to 70 nm and most preferably in a range of 30 to 50 nm. Below a mean thickness of 20 nm the PVD pigments become too dark and are more difficult to be processed in coating procedure. Above of a mean thickness of 80 nm the PVD pigment lose their typical properties regarding outstanding hiding power and the pigments are better produced by milling processes which is less cost intensive.

In preferred embodiments the platelet-like aluminum effect pigment is coated with an anticorrosive coating. This anticorrosive can consist of adsorbed additives based on e.g. phosphonic acids or on phosphoric esters. It can also comprise a metal oxide, a polymer or mixtures or combinations thereof. Such passivated aluminum pigments are used in waterborne coatings to prevent the degradation of the aluminum flakes by attack of water under formation of hydrogen gas.

However, surprisingly it was found that a passivation coating can also decrease the unwanted attenuation of radio waves. Therefore, when using such passivated aluminum pigments with suitable semiconductor effect pigments a synergetic effect evolve regarding the decrease of the attenuation of radio waves.

It is most preferred that the passivation coating is a metal oxide. A “metal oxide” in this case can mean a pure metal oxide but also includes a metal hydroxide or a metal oxide hydrate or any mixture thereof. Preferably, the metal oxide is selected from the group consisting of SiO₂, Cer-oxide, Mo-oxide, V-oxide, Cr-oxide and mixtures or combinations thereof. With combinations it is meant the order in which the metal oxides are coated onto the aluminum substrate. Most preferred are SiO₂, Mo-oxide and any mixture or combination thereof and very preferred is SiO₂.

Examples of such commercially available aluminum pigments are Hydrolan® (Eckart GmbH), or Emeral® (Toyo Aluminium K.K., Japan).

The passivating coating does not or only very slightly alter the optical properties of the aluminum effect pigment. Particularly, it does not add any color the silvery aluminum effect pigment.

In all embodiments where the passivating layer is formed by a metal oxide coating, the outermost metal oxide coating is preferably further modified by an organofunctional silane, aluminate, titanate or zirconate and most preferably by an organofunctional silane. These so called “coupling agents” enable to form a chemical bonding to a binder of a varnish or a paint on one side and to connect chemically to the metal effect pigment's surface. These organofunctional groups can also be called coupling groups or functional binding groups and are preferably selected from the group consisting of hydroxyl, amino, acryl, methacryl, vinyl, epoxy, isocyanate, cyano and mixtures thereof.

The organofunctional silanes, preferably used as coupling agents, which contain suitable functional groups are available commercially and are produced for example by Evonik and sold under the trade name “Dynasylan”. Other products can be obtained from Momentive (Silquest silanes) or from Wacker, for example standard silanes from the GENIOSIL product group.

Examples of these organofunctional silanes are 3-methacryloxypropyltrimethoxysilane (Dynasylan MEMO, Silquest A-174NT), vinyltri(m)ethoxysilane (Dynasylan VTMO and VTEO respectively, Silquest A-151 and A-171 respectively), methyltri(m)ethoxysilane (Dynasylan MTMS and MTES respectively), 3-mercaptopropyltrimethoxysilane (Dynasylan MTMO; Silquest A-189), 3-glycidoxypropyltrimethoxysilane (Dynasylan GLYMO, Silquest A-187), tris[3-(trimethoxysilyl)propyl]isocyanurate (Silquest Y-11597), bis[3-(triethoxysilyl)propyl)]tetrasulfide (Silquest A-1289), bis[3-(triethoxysilyl)propyldisulfide (Silquest A-1589), beta-(3,4-epoxycyclohexyl)ethyltrimethoxysilane (Silquest A-186), bis(triethoxysilyl)ethane (Silquest Y-9805), gamma-isocyanatopropyiltrimethoxysilane (Silquest A-Link 35, GENIOSIL GF40), methacryloxymethyltri(m)ethoxysilane (GENIOSIL XL 33, XL 36), (methacryloxymethyl)(m)ethyldimethoxysilane (GENIOSIL XL 32, XL 34), (isocyanatomethyl)methyldimethoxysilane, (isocyanatomethyl)trimethoxysilane, 3-(triethoxysilyl)propyl succinic anhydride (GEN10SIL GF 20), (methacryloxymethyl)methyldiethoxysilane, 2-acryloxyethylmethyldimethoxysilane, 2-methacryloxyethyltrimethoxysilane, 3-acryloxypropylmethyldimethoxysilane, 2-acryloxyethyltrimethoxysilane, 2-methacryloxyethyltriethoxysilane, 3-acryloxypropyltrimethoxysilane, 3-acryloxypropyltripropoxysilane, 3-methacryloxypropyltriethoxysilane, 3-methacryloxypropyltriacetoxysilane, 3-methacryloxypropylmethyldimethoxysilane, vinyltrichlorosilane, vinyltrimethoxysilane (GENIOSIL XL 10), vinyltris(2-methoxyethoxy)silane (GENIOSIL GF 58), vinyltriacetoxysilane or mixtures thereof.

The following are preferably used as organofunctional silanes: 3-methacryloxypropyltrimethoxysilane (Dynasylan MEMO, Silquest A-174NT), vinyltri(m)ethoxysilane (Dynasylan VTMO and VTEO respectively, Silquest A-151 and A-171 respectively), methyltri(m)ethoxysilane (Dynasylan MTMS and MTES respectively), beta-(3,4-epoxycyclohexyl)ethyltrimethoxysilane (Silquest A-186), bis(triethoxysilyl)ethane (Silquest Y-9805), gamma-isocyanatopropyltrimethoxysilane (Silquest A-Link 35, GENIOSIL GF40), methacryloxymethyltri(m)ethoxysilane (GENIOSIL XL 33, XL 36), (methacryloxymethyl)(m)ethyldimethoxysilane (GENIOSIL XL 32, XL 34), 3 (triethoxysilyl)propyl succinic anhydride (GENIOSIL GF 20), vinyltrimethoxysilane (GENIOSIL XL 10) and/or vinyltris(2-methoxyethoxy)silane (GENIOSIL GF 58). Furthermore, aqueous prehydrolyzates, for example available commercially from Evonik, can be used. These include, inter alia, aqueous pre-condensated aminosiloxane (Dynasylan Hydrosil 1151), aqueous amino/alkylfunctional siloxane (Dynasylan Hydrosil 2627 or 2909), aqueous diaminofunctional siloxane (Dynasylan Hydrosil 2776), aqueous, aqueous epoxyfunctional siloxane (Dynasylan Hydrosil 2926), amino/alkylfunctional oligosiloxane (Dynasylan 1146), vinyl/alkylfunctional oligosiloxane (Dynasylan 6598), oligomeric vinylsilane (Dynasylan 6490) or oligomeric shortchain alkylfunctional silane (Dynasylan 9896).

In one preferred embodiment, the organofunctional silane mixture contains, in addition to at least one silane without a functional binding group, at least one aminofunctional silane.

The amino function is a functional group which can enter into one or more chemical interactions with most of the groups present in binders. This can involve a covalent bond, such as e.g. with isocyanate- or carboxylate-functions of the binder, or hydrogen bridge bonds such as with OH- or COOR-functions or also ionic interactions. An amino function is therefore very well-suited to the purpose of chemically binding the pigment to various binders.

The following compounds are preferably used for this: 3-aminopropyltrimethoxysilane (Dynasylan AMMO; Silquest A-1110), 3-aminopropyltriethoxysilane (Dynasylan AMEO), [3-(2-aminoethyl)-aminopropyl]trimethoxysilane (Dynasylan DAMO, Silquest A-1120), [3-(2-aminoethyl)-aminopropyl]triethoxysilane, triaminofunctional trimethoxysilane (Silquest A-1130), bis-(gamma-trimethoxysilylpropyl)amine (Silquest A-1170), N-ethyl-gammaaminoisobutyltrimethoxysilane (Silquest A-Link 15), N-phenyl-aminopropyltrimethoxysilane (Silquest Y-9669), 4-amino-3,3-dimethylbutyltrimethoxysilane (Silquest A-1637), N-cyclohexylaminomethylmethyldiethoxysilane (GENIOSIL XL 924), Ncyclohexylaminomethyltriethoxysilane (GENIOSIL XL 926), N-phenylaminomethyltrimethoxysilane (GENIOSIL XL 973) or mixtures thereof

In a further preferred embodiment, the silane without a functional binding group is an alkyl silane. The alkyl silane preferably has the formula R_{(4-z)}Si(X)₂. In this formula, z is an integer from 1 to 3, R is a substituted or unsubstituted, unbranched or branched alkyl chain of 10 to 22 C atoms, and X is a halogen and/or alkoxy group. Preferred alkyl silanes are those with alkyl chains of at least 12 C atoms.

Aluminum effect pigments treated with such kind of after-coatings are described in EP 1084198 B2 and EP 3080209 B1.

All these organofunctional silanes can be also used to modify the surface of the flaky single layered semiconductor effect pigment.

### Silvery Absorbing Pearlescent Pigments:

The effect pigment mixture can be a mixture form flaky single layered semiconductor effect pigments and silvery absorbing pearlescent pigments. In another embodiments the effect pigment mixture can contain flaky metal effect pigments, flaky single layered semiconductor effect pigments and silvery absorbing pearlescent pigments.

The silvery absorbing pearlescent pigments are composed of transparent non-conducting substrates coated with metal oxide layers of refractive index>1.8 in the visible wavelength region which have absorbing properties in the visible wavelength range. These effect pigments can be also called as “dielectrics”. These additional pearlescent pigments offer good brightness and are also radar transparent, but usually are less opaque compared to metal effect pigments and to the flaky single layered semiconductor effect pigments. They have optical properties reflecting a metallic look.

The silvery absorbing pearlescent pigments can be colored to impart a color impression to the effect pigment mixture. In other embodiments the silvery absorbing pearlescent pigments have a silvery color tone in reflection.

These pearlescent pigments usually have optical properties such that the resulting color in reflection is essentially a neutral silver tone or a slightly colored tone and cover a region from absorbing grey to anthracite shades. With respect to pearlescent pigments generally the color tone “anthracite” is also often referred to as “black”. In this invention the term “silvery absorbing pearlescent pigments” is used for pearlescent pigments which have a combination of neutral silver or slightly colored reflection color and grey to anthracite absorption color tones providing a metallic-like characteristic. These pearlescent pigments are known to have a stronger opacity compared to transparent pearlescent pigments. These pearlescent pigments were essentially described in US 2022/0145082 A1.

The optical properties of the silvery pearlescent pigments optionally useable for the effect pigment mixture can be evaluated by making a drawdown of a colorless lacquer (preferably BASF farblos ZM 26-3025) with a pigment concentration of 10 wt.-% of the pearlescent pigment using a 100 μm doctor blade on a black/white cartoon paper. The total content of non-volatile components in the lacquer should be 30 wt.-%. The optical properties of the dried drawdowns are measured with a BYK-Mac instrument.

Preferably, the chroma C*15° of such a drawdown of the silvery pearlescent pigments measured on black background is ≤15, more preferably ≤14, furthermore preferably ≤10 and most preferably ≤5.

The hiding power of the silvery pearlescent pigment in such drawdowns can be defined as the ratio of the L*_{75°,black}/L*_{75°,white}-values measured on the black to white background, respectively. This ratio is preferably higher than 70%.

This high hiding power is mainly achieved by the absorbing layer of the pearlescent pigments.

The lightness is represented by the L*15° value which is close to the angle of reflection and preferably this value measured on the drawdowns on black background is above 90 and more preferably above 100 for the pearlescent pigments of the effect pigment mixture.

In preferred embodiments the silvery absorbing pearlescent pigments are chosen from the group consisting of:
α) pearlescent pigments comprising a transparent substrate which is coated with a high-refractive index layer with n>1.8, which comprises or consists of an iron-oxide with Fe(II)-ions,
β) pearlescent pigments comprising a transparent substrate which is coated with a high-refractive index layer with n>1.8, which comprises or consists of titanium suboxide or a pearlescent pigment comprising a substrate with a high-refractive index with n>1.8 layer, which comprises or consists of a titanium suboxide that is optionally coated with a high-refractive index layer with n>1.8,
χ) pearlescent pigments comprising a transparent substrate which is coated with a high-refractive index layer with n>1.8, which comprises or consists of titanium oxynitride,
δ) pearlescent pigments comprising a transparent substrate which is coated with a layer comprising carbon, wherein the carbon is enclosed in a particulate form in another metal oxide layer or is formed as a separate, individual layer,
ε) a transparent substrate coated with a first layer comprising or consisting of a mixture of the oxides of titanium, iron and at least one of cobalt and chromium and a second layer on the first layer, wherein the second layer comprises an oxide of titanium, and mixtures or combinations of the silvery absorbing pearlescent pigments α) to ε).

In a first preferred embodiment α) the silvery pearlescent pigments used in certain of the effect pigment mixtures are pearlescent pigments comprising a transparent substrate which is coated with a high-refractive index layer with n>1.8, which comprises or consists of an iron-oxide with Fe(II)-ions.

In a preferred embodiment the silvery pearlescent pigment α) has a coating comprising a metal oxide layer comprising Ti and Fe, wherein the iron is mainly Fe(II) ions, which is preferably an ilmenite (FeTiO₃) layer or a magnetite (Fe₃O₄) layer or mixtures thereof.

In a further preferred embodiment the pearlescent pigment has a coating comprising a first layer of TiO₂ followed by a metal oxide layer containing Fe(II)-ions, preferably consisting of ilmenite. Pearlescent pigments with a coating comprising a homogeneously distributed ilmenite (FeTiO₃) have been described in EP 1620511 A2. Pearlescent pigments with a coating comprising first a TiO₂ layer followed by an inhomogeneously distributed ilmenite layer have been described in WO 2012/130776 A1.

Further examples of such pearlescent pigments are disclosed in EP 246523 A2, EP 3119840 A1 (with an Al₂O₃ substrate) or EP 681009 A2 (with a further high-refractive index coating). Pearlescent pigments with a single layer of ilmenite on a TiO₂ platelet substrate have been described in WO 1997/043348 A1. The thicknesses of the layers disclosed in these documents need to be reduced in order to achieve the silvery to grey shaded pearlescent pigments in reflection as demanded in the effect pigment mixture.

In further preferred embodiments the silvery pearlescent pigment comprises the following structure:
(i) a transparent platelet-shaped synthetic substrate,
(ii) a titanium oxide layer, followed by
(iii) a metal oxide layer comprising Ti- and Fe-ions, wherein the Fe-ions are mainly Fe(II)-ions.

In a further preferred embodiment the silvery pearlescent pigment has a layer of ilmenite (FeTiO₃).

In further preferred embodiments the pearlescent pigment has an iron (III) oxide content of less than 0.5% by weight, based on the total weight of the pigment. All other amounts of Fe-ions in iron oxides are in the reduced Fe(II) oxidation state.

A higher amount of remaining Fe(III)-ions would lead to an undesired brownish absorption color.

The amounts of Fe(II) or Fe(III) can be determined with Mößbauer spectroscopy or with XPS analysis, possibly combined with sputter profiles.

In further embodiments the total amount of iron compounds, calculated as elemental iron, in the silvery absorbing pearlescent pigment is less than 5.0% by weight, preferably in a range from 1% by weight to 4.3% by weight, particularly preferably in a range from 1.4% by weight to 2.9% by weight and very particularly preferably in a range from 1.5% by weight to 2.3% by weight, based in each case on the total weight of the pearlescent pigment.

With such low amounts of Fe a silvery color can be well developed. Higher amounts than 5 wt.-% lead to pearlescent pigments with a too strong absorption color.

In further preferred embodiments the pearlescent pigment of type x) has an iron/titanium weight ratio as a function of the coating, in accordance with formula (I):

$$\frac{Iron content ( wt . \% )}{Titanium content ( wt . \% )} * Fraction of the coating ( wt . \% ) \qquad ( I )$$

is in a range from 1.0 to 25.0. Herein “iron content” stands for the amount of iron compounds, calculated as elemental iron, and “titanium content” stands for the amount of titanium compounds, calculated as elemental titanium, in each case in the silvery absorbing pearlescent pigment and based on the total weight of the silvery absorbing pearlescent pigment, and where the “fraction of the coating (% by weight)” stands for the weight fraction, based on the total weight of the silvery absorbing pearlescent pigment, of the overall coating applied to the substrate. Preferably this parameter is in a range from 2 to 8.0, particularly preferably in a range from 2.5 to 7.0, and very particularly preferably in a range from 3.0 to 6.0.

This parameter especially ensures that the pearlescent pigment has a silvery color as preferred in the effect pigment mixture.

In another embodiment B) the silvery pearlescent pigments comprise a transparent substrate which is coated with a high-refractive index layer with n>1.8 which comprises or consists of a titanium suboxide or a substrate with a high-refractive index n>1.8 layer comprising or consisting of a titanium suboxide that is optionally coated with a high-refractive index layer with n>1.8.

The high-refractive coating layer with n>1.8 of the second kind of pigment is made from a different material than the substrate's titanium suboxide and is preferably TiO₂.

The coated titanium suboxide layer or the titanium suboxide substrate denote to titanium oxides wherein the formal oxidation number of titanium is below 4. They can be represented by the formula:

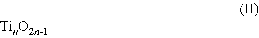

wherein n in an integer of 1 to 100, preferably n=1 to 10. Typical examples of such compounds are TiO, Ti₂O₃, Ti₃O₅, Ti₄O₇. Mixtures of any such species may be also included.

In further embodiments the titanium suboxide content can be less than 5% based on the total pigment and the main component of said titanium suboxide is Ti₂O₃.

An example of a commercially available pearlescent pigment with titanium suboxide is Iriodin® 9605 (Merck).

In another embodiment χ) the silvery pearlescent pigments comprise a transparent substrate which is coated with a high-refractive index layer with n>1.8, which comprises or consists of titanium oxynitride.

The titanium oxynitrides can be expressed by the general formula:

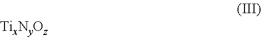

wherein x is 0.2 to 0.6, y is 0.05 to 0.6 and z is 0.1 to 0.9, which comprises a solid solution of nitrogen in titanium monoxide.

Such pearlescent pigments have been described in U.S. Pat. No. 4,623,396 A. Pearlescent pigments with intense blue color or a bluish fade have been described in EP 332071 A1 or in EP 735115 A1. Herein a first TiO₂ layer is reduced with ammonia at temperatures in the range of 750° C. to 850° C. If the optical thickness of the TiO₂ layer deposited in a first step is in the range of 50 to 100 nm silvery effect pigments are obtained.

In EP 842229 B1 pearlescent pigments are described were a platelet-like TiO₂ substrate is first formed by solidification of a hydrolysable aqueous solution of a titanium compound on an endless band. These substrates can be coated with further TiO₂ or other metal oxides and calcined under reducing conditions.

Examples of such pearlescent pigments are Paliocrom Blausilber L6000 and L6001, which have been earlier manufactured by BASF Colors and Effects GmbH.

In a further embodiment δ) the pearlescent pigment of the effect pigment mixture comprises a transparent substrate which is coated with a layer comprising carbon, wherein the carbon is enclosed in a particulate form in another metal oxide layer or is formed as a separate, individual layer on at least one high-refractive index layer.

In DE 4227082 A1 pearlescent pigments were disclosed, wherein pearlescent substrates or TiO₂ coated pearlescent pigments were coated with organofunctional silanes and calcined or pyrolyzed under inert gas atmosphere yielding a pearlescent pigment containing carbon in silica matrix and having a darker color. Similar pearlescent pigments were disclosed in DE 4227082 A1.

In EP 3230384 A1 a pearlescent pigment with metallic silvery look was disclosed where on top of a high-refractive index coating like TiO₂ a very thin pure carbon layer is coated via a fluidized-bed apparatus.

In a further embodiment ε) the pearlescent pigment of the effect pigment mixture comprises a transparent substrate platelet coated with a first layer comprising or consisting of a mixture of the oxides of titanium, iron and at least one of cobalt and chromium and a second layer on the first layer, wherein the second layer comprises an oxide of titanium.

Such pearlescent pigments have a black absorption color and are described in U.S. Pat. Nos. 6,361,593 B2 and 6,290,766 B1.

Commercially available products are Vegetable Black Olive (BASF Colors and Effects).

In further embodiments mixtures or combinations of the silvery absorbing pearlescent pigments α) to ε) itself or silvery absorbing pearlescent pigments with mixtures or combinations of the various coating layers mentioned in the silvery absorbing pearlescent pigments α) to ε) can be used.

For example, pearlescent pigments comprising a coating of mixtures or combinations of titanium suboxide and titanium oxynitride may be used.

In preferred embodiments the silvery pearlescent pigments are taken from the following group:
α) pearlescent pigments of type α), wherein the pearlescent pigment has a coating comprising a metal oxide layer comprising Ti- and Fe-ions, wherein the Fe-ions are mainly Fe(II) ions, which is preferably an ilmenite (FeTiO₃) layer, magnetite (Fe₃O₄) or mixtures thereof or
β) pearlescent pigments of type β), wherein the titanium suboxide can be represented by the formula

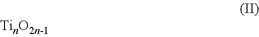

wherein n in an integer of 1 to 10, or
χ) pearlescent pigments of type χ), wherein the titanium oxynitride can be represented by the formula

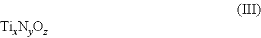

wherein x is 0.2 to 0.6, y is 0.05 to 0.6 and z is 0.1 to 0.9, which comprises a solid solution of nitrogen in titanium monoxide,
and mixtures or combinations of the pearlescent pigments α) to χ) or pearlescent pigments with mixtures or combinations of the various coating layers mentioned in the pearlescent pigments α) to χ).

The transparent substrates used for all kinds of the pearlescent pigments are typically natural or synthetic mica, glass flakes, SiO₂-flakes, Al₂O₃-flakes or mixtures thereof. Preferred substrates are glass flakes or synthetic mica as these substrates provide pearlescent pigments with pure silvery color tones and high gloss.

The high-refractive index layers of the silvery pearlescent pigments of type α), β) or χ) preferably have an index of refraction n of >2.0 and more preferably n>2.3.

In preferred embodiments the additional silvery absorbing pearlescent pigments according to the invention may be provided with at least one external protective layer. This protective layer further enhances the light stability, weather stability and/or chemical stability of the pearlescent pigment. Especially the photoactivity of any TiO₂ layers and the concomitant destroying of organic resins in coatings may be effectively reduced by these protective layers.

The external protective layer of these silvery absorbing pearlescent pigments according to the invention can comprise, or preferably consist of, one or two metal oxide layers and/or metal hydroxide layers and/or metal oxide hydrate layers of the elements Si, Al, Zr or Ce. In one variant, a silicon oxide layer, preferably SiO₂ layer, is applied as the outermost metal oxide layer. After these protective layer organofunctional coupling agents may be coated on the outermost protective layer as described above in the section dealing with aluminum effect pigments. In principle, the same kind of organofunctional coupling agents can be used as well for the silvery pearlescent pigments.

Such weather stable external protective layer are described in EP 0 888 410 B1, EP 0 632 109 A1, EP 1727864 B1, EP 1 682 622 B1, EP 2691478 B1 or EP 2904052 B1, for example.

These pearlescent pigments have been reported in US 2022/0145082 A1 to be used in mixture with metal effect pigments obtained from milling of metal powder for radar transparent coatings. Due to their rather high opacity such mixtures can match existing automotive silver full-tone formulations.

In the present invention, the use of single layered semiconductor flakes even stronger enhances the opacity and decreases the radar attenuation, so that even PVD aluminum metal pigments can be used as metal effect pigments.

In further embodiments conventional color pigments can be added to the effect pigment mixture to vary the overall color tones. With conventional pigments it is meant that these pigments do not have an angle dependency (either the angle of incidence or of observation) in their optical properties which is just contrary to effect pigments.

These conventional pigments are used to impart color to the resin mold, if demanded. The conventional pigment may be an organic pigment, an inorganic pigment or a mixture thereof.

Accordingly, in a preferred aspect, the conventional pigment is a transparent pigment, especially selected from the group consisting of an organic pigment, an inorganic pigment or a mixture thereof.

Organic colored absorption pigments suitable for the present coating formulation include, for example, a pigment selected from the group consisting of a monoazo, disazo, disazo condensation, anthanthrone, anthraquinone, anthrapyrimidine, benzimidazolone, quinacridone, quinophthalone, diketopyrrolopyrrole, dithioketopyrrolopyrrole, dioxazine, flavanthrone, isoindoline, isoindolinone, isoviolanthrone, metal complex, perinone, perylene, pyranthrone, pyrazoloquinazolone, indigo, thioindigo, triarylcarbonium pigment and a mixture thereof.

### Effect Pigment Mixtures:

In preferred embodiments the metal pigments are fabricated by milling and are especially aluminum effect pigments. The weight ratio of the flaky single layered semiconductor effect pigments to these metal effect pigments, especially aluminum effect pigments is preferably in a range of 0.10-5.00, more preferably in a range of 0.15-1.50 and most preferably in a range of 0.2-0.50.

In preferred embodiments the metal pigments are fabricated by PVD and are especially aluminum effect pigments. The weight ratio of the single platelet semiconductor effect pigments to these metal effect pigments, especially aluminum effect pigments is preferably in a range of 1.00-20.0, more preferably in a range of 1.50-20.0 and most preferably in a range of 2.00-15.0.

Below the lower limits of the above-mentioned ranges the radar attenuation is still too high, whereas above of the mentioned higher limits the opacity and metallic effect, especially brightness are too low.

In preferred embodiments regarding mixtures of the flaky single layered semiconductor effect pigments, metal effect pigments obtained by milling, especially aluminum effect pigments and pearlescent pigments, especially silvery absorbing pearlescent pigments the sum of the weight-% ratio of the semiconductor pigments and the pearlescent pigments to the weight of the metal pigments is in a range of 0.30-70.0, more preferably in a range of 0.40-20.00 and most preferably in a range of 0.6-3.00.

In preferred embodiments regarding mixtures of the single platelet semiconductor effect pigments, metal effect pigments obtained by PVD, especially aluminum effect pigments and pearlescent pigments, especially silvery absorbing pearlescent pigments the sum of the weight of the semiconductor pigments and the pearlescent pigments to the weight of the metal pigments is in a range of 2.0-100.0, more preferably in a range of 5.0-750.0 and most preferably in a range of 10.0-50.0.

The weight-% ratio of the single platelet semiconductor effect pigments to the pearlescent pigments, preferably silvery absorbing pearlescent pigments in mixtures in the absence of flaky, metal effect pigments is preferably in a range of 0.020-4.00, more preferably in a range of 0.04 to 3.00 and most preferably in a range of 0.05 to 0.20.

### Coating Formulations:

Other embodiments of the present invention are dedicated to coating formulations comprising the effect pigment mixtures described above. Such coating formulations comprise a binder, a solvent an effect pigment mixture and optionally further typical ingredients like additives fillers and the like and are radar transparent. The coating formulations can be formulated in certain aspects:

Aspect 1: A coating formulation comprising an effect pigment mixture comprising a mixture of flaky single layered semiconductor effect pigments and flaky metal effect pigments or a mixture of flaky single layered semiconductor effect pigments with silvery absorbing pearlescent pigments, wherein the flaky single layered semiconductor effect pigments have a bandgap in a range of 0.1 to 3.9 eV and preferably in a range of 0.2 to 1.4 eV.

Aspect 2: A coating formulation according to aspect 1, wherein the flaky single layered semiconductor effect pigments have an average atomic composition of:
a) Si₍₁₋ₓ₎Geₓ, wherein 0≤x<1.00 or
b) Si_{(1-y)}Sn_{y}, wherein 0<y<0.90 or
c) Ge_{(1-z)}Sn_{z}, wherein 0<z≤0.60 or
d) Si₍₁₋ₘ₋ₙ₎GeₘSnₙ, wherein 0<m<1.00, 0<n<1.00
with the provisos that x<1.00; y<1.00, z<1.00 and m+n<1.00.

Aspect 3: A coating formulation according to the preceding aspects wherein the flaky single layered semiconductor effect pigments have an average atomic composition of:
a) Si₍₁₋ₓ₎Geₓ, wherein 0.01<x<0.9 and preferably 0.02≤x≤0.8 or
b) Si_{(1-y)}Sn_{y}, wherein 0.02≤y≤0.75 and preferably 0.02≤y≤0.65 or
c) Ge_{(1-z)}Sn_{z}, wherein 0.02≤z≤0.5 and preferably 0.02≤z≤0.50 or
d) Si₍₁₋ₘ₋ₙ₎GeₘSnₙ, wherein 0.02≤m≤0.8, 0.02≤n≤0.75

Aspect 4: A coating formulation according to the preceding aspects wherein the flaky single layered semiconductor effect pigments have an average atomic composition of:
a) Si₍₁₋ₓ₎Geₓ, wherein 0.05≤x≤0.65 or
b) Si_{(1-y)}Sn_{y}, wherein 0.05≤y≤0.55 or
c) Ge_{(1-z)}Sn_{z}, wherein 0.05≤z≤0.4 or
d) Si₍₁₋ₘ₋ₙ₎GeₘSnₙ, wherein 0.05≤m≤0.65, 0.05≤n≤0.55.

Aspect 5: A coating formulation according to the preceding aspects, wherein the flaky metallic pigments are PVD aluminum pigments or aluminum pigments obtained by milling of aluminum powder.

Aspect 6: A coating formulation according to any of the preceding aspects, wherein the wt. % ratio of the flaky single layered semiconductor effect pigments to the flaky metal effect pigments is in a range of 0.10-5.00 for flaky metal effect pigments, especially aluminum effect pigments obtained by milling and in range of 1.00-20.0 for flaky metal effect pigments, especially aluminum effect pigments obtained by PVD.

Aspect 7: A coating formulation according to any of the preceding aspects, wherein the silvery absorbing pearlescent pigments are chosen from the group consisting of:
α) pearlescent pigments comprising a transparent substrate which is coated with a high-refractive index layer with n>1.8, which comprises or consists of an iron-oxide with Fe(II)-ions,
β) pearlescent pigments comprising a transparent substrate which is coated with a high-refractive index layer with n>1.8, which comprises or consists of titanium suboxide or a pearlescent pigment comprising a substrate with a high-refractive index with n>1.8 layer, which comprises or consists of a titanium suboxide that is optionally coated with a high-refractive index layer with n>1.8,
χ) pearlescent pigments comprising a transparent substrate which is coated with a high-refractive index layer with n>1.8, which comprises or consists of titanium oxynitride,
δ) pearlescent pigments comprising a transparent substrate which is coated with a layer comprising carbon, wherein the carbon is enclosed in a particulate form in another metal oxide layer or is formed as a separate, individual layer,
ε) a transparent substrate coated with a first layer comprising or consisting of a mixture of the oxides of titanium, iron and at least one of cobalt and chromium and a second layer on the first layer, wherein the second layer comprises an oxide of titanium, and mixtures or combinations of the silvery absorbing pearlescent pigments α) to ε).

Aspect 8: A coating formulation according to aspect 1, wherein the wt. % ratio of the flaky, single layered semiconductor effect pigments to the silvery absorbing pearlescent pigments in the absence of metal effect pigments is in a range of 0.020-4.00.

Aspect 9: A coating formulation according to aspects 1 to 8, wherein the effect pigment mixture comprises flaky single layered semiconductor effect pigments, flaky metal effect pigments and silvery absorbing pearlescent pigments.

Aspect 10: A coating formulation according to aspect 9, wherein the wt. % ratio of both the flaky single layered semiconductor effect pigments and the silvery absorbing pearlescent pigments to the flaky, metal effect pigments are in a range of 0.30-70.0 for metal effect pigments obtained by milling and in a range of 2.0-100.0 for metal effect pigments obtained by PVD.

Aspect 11: A coating formulation according to any of the preceding aspects, wherein the concentration of the flaky single layered semiconductor effect pigments is in a range of 0.3 to 4.0 wt. %, preferably in a range of 0.5 to 3.0 wt. % when used together with aluminum effect pigments obtained by milling and is in a range of 1.0 to 4.0 wt. %, preferably in a range of 2.0 to 3.5 wt. % when used together with aluminum effect pigments obtained by PVD, each based on the total weight of the coating formulation.

Aspect 12: A coating formulation according to any of the preceding aspects, wherein the concentration of the flaky metal effect pigments is in a range of 0.80 to 3.0 wt. %, preferably in a range of 1.0 to 2.5 wt. % for milled aluminum effect pigments and in a range of 0.10 to 1.00 wt. %, preferably of 0.15 to 0.80 wt. % for aluminum effect pigments produced by PVD, each based on the total weight of the coating formulation.

Aspect 13: A coating formulation according to any of the preceding aspects, wherein the concentration of all effect pigments is in a range of 0.8 to 5.0 wt. %, and preferably in a range of 2.5 to 4.5 wt. %, each based on the total weight of the coating formulation.

Other embodiments of this invention are dedicated to the use of the effect pigment mixtures in coating formulations. All embodiments disclosed in this invention are also applicable to such uses.

### EXAMPLES

### Comparative Example 1: (Single Semiconductor Flake)

A silicon and tin blend was obtained via a co-deposition of separated silicon and tin sources on a 30 cm wide clear polyester film coated with an ethyl cellulose-based releasing agent using ebeam PVD evaporation. The ebeam sources were positioned 36 cm below the web and during the evaporation process the conditions were modified to achieve a silver coloration for the final pigment. The ebeam source accelerating voltage was held at a constant 10 kV throughout the run. The obtained SiSn alloy film obtained was stripped from the polyester film with acetone in a stripping chamber and comminuted to a median particles size of 15.4 μm (D₅₀ value). The SiSn dispersion was finally prepared at 10 wt. % non-volatile content in propylene glycol monomethyl ether. The average particle thickness t_{sc}, obtained via SEM analysis, is 26+/−3 nm. The elemental silicon:tin atomic ratio determined from energy dispersive spectroscopy is 73:27.

### Comparative Example 2: (Flaky Aluminum PVD Pigment)

Commercially available Metalure C21010AE (Eckart GmbH, Germany), being a dispersion with 10 wt. % aluminium flakes in ethyl acetate. The average thickness of the aluminum flakes was about 32 nm.

### Example Series 1

The two effect pigments from Comparative Examples 1 and 2 were used as blend materials. The SiSn PVD alloys of Comparative Example 1, as shown below, displays near-zero effective radar opacity within measurement detection limits. The Metalure C21010AE suspensions at 10 wt. % non-volatile content in ethyl acetate was blended with the SiSn PVD dispersions at weight ratios of 0:100, 10:90, 20:80, 30:70, and 100:0 (metal to semiconductor wt.-ratios).

A binder formulation was made by mixing and stirring 43.5 parts of NC E 1160 (DuPont Nutrition and Biosciences) binder in isopropyl alcohol having a binder content of 9 wt.-% were further mixed together with 26.5 parts butyl acetate, 26.5 parts xylol, 0.6 parts butyl diglycol, 1.6 parts butyl glycol to which 1.3 parts of dispersing additives were added. The binder content of this dispersion was 3.925 wt. %. The respective effect pigment dispersions were added under careful stirring and the ratio of the total weight of all effect pigments to the binder was always 1:4.2.

Viscosity was adjusted using a 1:1 solvent mixture of butyl acetate and xylol. Spray coatings of the low solid formulations were applied to ABS panels having a black/white visual opacity sticker using a spray-coating apparatus APL 3.3 from Company Oerter, Germany. Each formulation was sprayed as often until full-tone coverage of each sprayed sample was achieved.

The radar transparency measurements were conducted with microwave radiation at a frequency of 76.5 GHz using as a measurement system an RMS-D-77/79G apparatus from Perisens GmbH, Germany. The data displayed in the following tables were background corrected to account for loss produced by the uncoated substrate. The radar attenuation is expressed in decibel (dB) and must be lower than 3.0.

Additional optical data were collected using a BYK Mac colorimeter. The flop was calculated according to the common formula:

$$Flop index = 2.69 \times {( {L}_{15 °}^{*} - {L}_{110 °}^{*} )}^{1.11} / {L}_{45 °}^{* 0.86}$$

The formulation ratios and radar attenuations results are displayed in Table 1a, while the results of optical measurements are displayed in Table 1b.

TABLE 1a
Formulation ratios and Average Radar Attenuation for Example series 1

| | | | Average | |
|---|---|---|---|---|
| | Al wt % | SiSn wt % | Radar | |
| | (10% | (10% | Attenuation | Coates |
| | suspen- | suspen- | in dB @ | required for |
| Samples | sion) | sion) | 76.5 GHz | Coverage |
| Comp. Ex. 1 | 0 | 100 | 0.09 | 4 |
| Ex. 1a | 10 | 90 | 0.15 | 4 |
| Ex. 1b | 20 | 80 | 0.41 | 4 |
| Ex. 1c | 30 | 70 | 0.77 | 4 |
| Comp. Ex. 2 | 100 | 0 | 6.5 | 4 |

TABLE 1b
Results of optical measurements of Example 1 series

| Samples | Flop | L *_{-15°} | L*_{15°} | L*_{25°} | L*_{45°} | L*_{75º} | L*_{110°} | C*_{15°} |
|---|---|---|---|---|---|---|---|---|
| Comp. | 27.6 | 132.6 | 112.7 | 65.5 | 27.4 | 11.5 | 6.9 | 2.1 |
| Ex. 1 | | | | | | | | |
| Ex. 1a | 28.5 | 138.0 | 115.9 | 65.9 | 27.2 | 11.9 | 7.6 | 2.4 |
| Ex. 1b | 28.7 | 144.5 | 121.8 | 69.1 | 28.5 | 13.1 | 8.5 | 2.2 |
| Ex. 1c | 28.6 | 149.7 | 125.4 | 70.6 | 29.3 | 14.5 | 10.2 | 2.1 |
| Comp. | 26.8 | 155.1 | 127.9 | 71.0 | 30.6 | 18.4 | 15.5 | 1.2 |
| Ex. 2 | | | | | | | | |

The 100% SiSn sample (Comp. Ex. 1) displayed near-zero radar attenuation values within the detection limit (~0.1 dB) of the measurement system, a brightness value (L*_{15°}) of 112.7, and a flop value of 27.6. The Comparative Example 2 (pure Metalure C21010AE) displayed a radar attenuation value of 6.5 dB, a brightness value (L*_{15°}) of 127.9, and a flop value of only 26.8. Increasing the weight ratio of the aluminum pigment dispersion resulted in a concomitant non-linear increase in brightness) (L*_{15°}), and radar attenuation values.

The 70:30 SiSn:C21010AE (of Example 1c) weight ratio showed surprisingly a brightness already very close to Comparative Example 2, but with substantially reduced radar attenuation of 0.77 dB.

Surprisingly, the flop values of all effect pigment mixtures were slightly higher than the values of the single effect pigments.

The coverage of all samples were quite similar as always four spray coatings were needed to achieve full coverage. Thus mixtures of the PVD aluminum pigments with the SiSn alloy pigment surprisingly seem to have similar coverage as the pure flaky metal pigments. The data shows that blending of SiSn with aluminum substantially reduces overall radar attenuation, while maintaining similar brightness, opacity and flop performance relative to the pure PVD aluminum pigment (Comparative Example 2).

### Example Series 2

As flaky metal pigment commercially available Hydroshine WS 3001 (a silica coated PVD aluminum pigment with about 13 wt.-% SiO₂ dispersed in isopropanol at about 10 wt. % total effect pigment)) and as pearlescent effect pigments commercially available Symic Opaque Medium B604 pearlescent pigments were used as a blending materials (all from Eckart GmbH). Symic Opaque Medium B604 is a silvery absorbing pearlescent pigment having a high refractive index coating comprising TiO₂ and iron-oxide which contain Fe(II) ions.

As a third effect pigment a further experimental SiSn alloy PVD pigment was manufactured in a similar matter as according to Comparative Example 1 using a different silicon tin blend ratio. The average particle thickness t_{sc}, obtained via SEM analysis, is 29+/−3 nm. The slurry of the SiSn particles was homogenized to 14.2 μm (d₅₀). The elemental silicon:tin atomic ratio determined from energy dispersive spectroscopy is 67:33. The SiSn dispersion was prepared at 10 wt. % non-volatile content (NVM) in propylene glycol monomethyl ether. SiSn PVD alloys, as shown in Example 1, displays near-zero effective radar opacity within measurement detection limits.

The weight ratios of the three effect pigments used for blending (Hydroshine WS 3001, SiSn alloy and Symic Opaque Medium B604) are shown in Table 2a.

The three effect pigments were formulated in the binder formulation described in Example series 1 at two different relative weight ratios with a ratio of all effect pigments to the binder 1:4.2, respectively.

Multiple spray coatings were formulated as described above. Measurements of radar attenuation and optical data of sprayed and dried panels were measured as described above.

TABLE 2a
Composition and Radar attenuation data for Example 2 series

| | Al wt. % | | | | |
|---|---|---|---|---|---|
| | Hydroshine | | | Average | Coates |
| | WS 3001 | SiSn wt % | Symic wt % | Attenuation | Required |
| | 10% | (10% | (100% | in dB @ | for |
| Sample | suspension) | suspension) | solids) | 76.5 GHZ | Coverage |
| Example 2a | 15 | 42.5 | 42.5 | 0.54 | 6 |
| Example 2b | 35 | 32.5 | 32.5 | 2.01 | 6 |

TABLE 2b
Results of evaluation optical appearance Examples 2 series

| Samples | Flop | L *_{-15°} | L*_{15°} | L*_{25°} | L*_{45°} | L*_{75º} | L*_{110°} | C*_{15°} |
|---|---|---|---|---|---|---|---|---|
| Example | 26.0 | 148.9 | 126.2 | 72.7 | 32.3 | 17.4 | 12.1 | 1.7 |
| 2a | | | | | | | | |
| Example | 26.2 | 157.1 | 132.8 | 75.7 | 33.6 | 19.2 | 14.6 | 1.1 |
| 2b | | | | | | | | |

The data displayed in tables 2a and 2b are averaged from two independent sprayings which had quite similar optical and radar attenuation characteristics. The sample set of SiSn:WS 3001:Symic (32.5:35:32.5) exceeds the brightness (L*_{15°}) level of the C21010AE (Comparative Example 2) at ~133. RADAR attenuation values are also superior to the Comparative Example at ~2. The sample set of SiSn:WS3001:Symic (42.5:15:42.5) is near the brightness level of the C21010AE Comparative Example at ~126 and the radar attenuation value is far superior to the Comparative Example 2 at ~0.5. The flop index of all examples in Table 2 is comparable to the C21010AE Comparative Example, while gloss values increase concomitant with aluminum weight ratio.

The opacity is not as good as pure PVD aluminum pigments as six spray coatings were needed to obtain visual complete hiding. This is attributed to the presence of the silvery absorbing pearlescent pigment which apparently has a lower opacity than the single flakes from the SiSn alloy and also to the fact that WS Hydroshine 3001 has a silica coating which decreases the opacity compared to a pure aluminum flake.

The data shows that blending of a SiSn flake with aluminum and synthetic mica based pearlescent pigment substantially reduces overall radar attenuation, while maintaining or exceeding brightness with similar flop performance relative to the Comparative Example 2.

1. Effect pigment mixture comprising a mixture of flaky single layered semiconductor effect pigments and flaky metal effect pigments or a mixture of flaky single layered semiconductor effect pigments with silvery absorbing pearlescent pigments, wherein the flaky single layered semiconductor effect pigments have a bandgap in a range of 0.1 to 3.9 eV.

2. Effect pigment mixture according to claim 1, wherein the band gap of the flaky, single layered semiconductor effect pigments is in a range of 0.2 to 1.4 eV.

3. Effect pigment mixture according claim 1, wherein the flaky single layered semiconductor effect pigments have an average atomic composition of:
a) Si₍₁₋ₓ₎Geₓ, wherein 0≤x≤1.00 or
b) Si_{(1-y)}Sn_{y}, wherein 0<y<0.90 or
c) Ge_{(1-z)}Sn_{z}, wherein 0<z≤0.60 or
d) Si₍₁₋ₘ₋ₙ₎GeₘSnₙ, wherein 0<m<1.00, 0<n<1.00 and with the proviso that m+n<1.00.

4. Effect pigment mixture according to claim 1, wherein the flaky single layered semiconductor effect pigments have an average atomic composition of:
a) Si₍₁₋ₓ₎Geₓ, wherein 0.005<x<0.9 or
b) Si_{(1-y)}Sn_{y}, wherein 0.005≤y≤0.75 or
c) Ge_{(1-z)}Sn_{z}, wherein 0.005≤z≤0.5 or
d) Si₍₁₋ₘ₋ₙ₎GeₘSnₙ, wherein 0.005≤m≤0.8, 0.005≤n≤0.75 and with the proviso that m+n<1.00.

5. Effect pigment mixture according to claim 1, wherein the flaky single layered semiconductor effect pigments have an average atomic composition of:
a) Si₍₁₋ₓ₎Geₓ, wherein 0.05≤x≤0.65 or
b) Si_{(1-y)}Sn_{y}, wherein 0.05≤y≤0.55 or
c) Ge_{(1-z)}Sn_{z}, wherein 0.05≤z≤0.4 or
d) Si₍₁₋ₘ₋ₙ₎GeₘSnₙ, wherein 0.05≤m≤0.65, 0.05≤n≤0.55 and with the proviso that m+n<1.00.

6. Effect pigment mixture according to claim 1, wherein the average thickness t_{sc} of the single layered semiconductor effect pigments is in a range of 5 to 160 nm.

7. Effect pigment mixture according to claim 1, wherein the flaky metallic pigments are PVD aluminum pigments or aluminum pigments obtained by milling of aluminum powder.

8. Effect pigment mixture according to claim 1, wherein the wt. % ratio of the flaky single layered semiconductor effect pigments to the flaky metal effect pigments is in a range of 0.10-5.00 for flaky metal effect pigments.

9. Effect pigment mixture according to claim 1, wherein the silvery absorbing pearlescent pigments are chosen from the group consisting of:
a) pearlescent pigments comprising a transparent substrate which is coated with a high-refractive index layer with n>1.8, which comprises an iron-oxide with Fe(II)-ions,
b) pearlescent pigments comprising a transparent substrate which is coated with a high-refractive index layer with n>1.8, which comprises titanium suboxide or a pearlescent pigment comprising a substrate with a high-refractive index with n>1.8 layer, which comprises a titanium suboxide that is optionally coated with a high-refractive index layer with n>1.8,
c) pearlescent pigments comprising a transparent substrate which is coated with a high-refractive index layer with n>1.8, which comprises titanium oxynitride,
d) pearlescent pigments comprising a transparent substrate which is coated with a layer comprising carbon, wherein the carbon is enclosed in a particulate form in another metal oxide layer or is formed as a separate, individual layer,
e) a transparent substrate coated with a first layer comprising a mixture of the oxides of titanium, iron and at least one of cobalt and chromium and a second layer on the first layer, wherein the second layer comprises an oxide of titanium, and
f) mixtures or combinations of the silvery absorbing pearlescent pigments a) to e).

10. Effect pigment mixture according to claim 1, wherein the wt. % ratio of the flaky, single layered semiconductor effect pigments to the silvery absorbing pearlescent pigments in the absence of metal effect pigments is in a range of 0.020-4.00.

11. Effect pigment mixture according to claim 1, wherein the effect pigment mixture comprises flaky single layered semiconductor effect pigments, flaky metal effect pigments and silvery absorbing pearlescent pigments.

12. Effect pigment mixture according to claim 11, wherein the wt. % ratio of both the flaky single layered semiconductor effect pigments and the silvery absorbing pearlescent pigments to the flaky, metal effect pigments are in a range of 0.30-70.0 for metal effect pigments obtained by milling and in a range of 2.0-100.0 for metal effect pigments obtained by PVD.

13. Radar transparent coating formulation comprising the effect pigment mixture of claim 1.

14. Radar transparent coating formulation comprising the effect pigment mixture of claim 11.
